(19) United States
(12) Patent Application Publication
(10) Pub. No.: US 2024/0362467 A1
(43) Pub. Date: Oct. 31, 2024

(54) AI-INFORMED WORKFLOW PROCESSING

(71) Applicant: Box, Inc., Redwood City, CA (US)

(72) Inventors: Nachiket Deo, San Jose, CA (US); Iyer Nirmal Ganesh, San Jose, CA (US); Virender Gupta, Morganville, NJ (US); Benjamin John Kus, Alameda, CA (US); Denis Grenader, Redwood City, CA (US)

(73) Assignee: Box, Inc., Redwood City, CA (US)

(21) Appl. No.: 18/375,923

(22) Filed: Oct. 2, 2023

Related U.S. Application Data
(60) Provisional application No. 63/527,534, filed on Jul. 18, 2023.
(60) Provisional application No. 63/463,049, filed on Apr. 30, 2023.

(51) Int. Cl. G06N 3/0475

(52) U.S. Cl. CPC G06N 3/0475

(57) ABSTRACT

A method for processing content management system workflows. Systems and subsystems are established for configuring a content management system to implement workflow processes wherein the content management system (CMS) exposes instances of stored content objects to a plurality of user devices through an electronic interface. Further systems and subsystem are established for identifying metadata maintained by the CMS for the stored content objects, and for identifying a generative AI entity (GAIE) to interact with the CMS. On an ongoing basis, the foregoing systems and subsystems carry out steps for (1) forming a GAIE prompt, wherein the GAIE prompt comprises at least a portion of the metadata identified from the CMS for the stored content objects, (2) receiving a response from the GAIE, wherein the response corresponds to the GAIE prompt; and (3) using, by the CMS, the response from the GAIE to implement processing of a content management system workflow.

### RELATED APPLICATIONS

The present application claims the benefit of priority to U.S. Provisional Patent Application Ser. No. 63/527,534 titled “GENERATIVE ARTIFICIAL INTELLIGENCE PROMPT GENERATION USING EXAMPLE QUESTION EMBEDDINGS” filed on Jul. 18, 2023, which is hereby incorporated by reference in its entirety; and the present application claims the benefit of priority to U.S. Provisional Patent Application Ser. No. 63/463,049 titled “ARTIFICIAL INTELLIGENCE AGENTS INTEGRATED WITH A CONTENT MANAGEMENT SYSTEM” filed on Apr. 30, 2023, which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### TECHNICAL FIELD

This disclosure relates to content management systems, and more particularly to techniques for AI-informed workflow processing.

### BACKGROUND

Computer scientists have long sought after practical applications where use of artificial intelligence (AI) eases the burden placed on humans when the human is tasked with performance of sophisticated tasks (e.g., reading medical images such as X-rays or MRI scans). Fortunately, this quest has advanced the art of using AI and/or has otherwise quantitatively improved results of using such AI. For example, it has recently been shown that, statistically speaking, an AI entity that is tasked with reading hundreds of x-rays or other medical images returns diagnostics that are far more complete and accurate than are the diagnostics provided by a human medical technician whose diagnoses is based on the same x-rays or other medical images. The far more complete and accurate diagnoses provided by an AI entity serve to inform the urgency and nature of downstream medical attention, such as where a skilled physician or nurse is able triage a patient, and/or to recommend specific medical procedures, and/or to recommend specific therapies.

The foregoing is merely one example. It is a practical application involving use of AI to inform downstream processing by humans. However, when considering the number of decisions made by computer (e.g., made on behalf of humans) there are literally millions of use cases where an AI entity can be employed to inform the computer such that more informed (e.g., better) decisions can be made by the computer. For example, in modern times, computer data of any ilk is stored in computer files that are in turn managed by a content management system (CMS). Also, in modern times, content management systems are deployed replete with CMS workflows that access the computer data of the content management system. Such workflows are designed to ease the burden placed on users of the CMS. Given the state of the art as pertains to CMS workflows, and excepting for certain trivial cases, use of CMS workflows often demand user intervention in order to advance through certain decision points in the workflow.

Unfortunately, this need for user intervention in order to advance through the workflow severely limits the overall utility of the workflow. In fact, in legacy approaches involving humans, there are certain situations where human intervention needed to foster progression through the workflow takes more human effort than if the human had dealt with the workflow without the ‘help’ that is putatively derived from the existence of, and automated operation of, the workflow. What is needed here is a way to reduce or eliminate the need for human intervention when progressing through a CMS workflow.

The problem to be solved is therefore rooted in various technological limitations of legacy approaches. Improved technologies are needed. In particular, improved applications of technologies are needed to address the aforementioned technological limitations of legacy approaches.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for AI-informed workflow processing, which techniques advance the relevant technologies to address technological issues with legacy approaches. More specifically, the present disclosure describes techniques used in systems, methods, and in computer program products for using responses from an AI entity to automate the triggering of a workflow. Certain embodiments are directed to technological solutions for using AI responses to inform computer-implemented workflows.

The disclosed embodiments modify and improve beyond legacy approaches. In particular, the herein-disclosed techniques provide technical solutions that address the technical problems attendant to eliminating the need for human intervention during processing of computer-implemented workflows. Such technical solutions involve specific implementations (e.g., data organization, data communication paths, module-to-module interrelationships, etc.) that relate to the software arts for improving computer functionality.

The ordered combination of steps of the embodiments serve in the context of practical applications that perform steps for using AI responses to inform computer-implemented workflows more efficiently. As such, techniques for using AI responses to inform computer-implemented workflows overcome long-standing yet heretofore unsolved technological problems associated with eliminating the need for human intervention during processing of computer-implemented workflows that arise in the realm of computer systems.

Many of the herein-disclosed embodiments for using AI responses to inform computer-implemented workflows are technological solutions pertaining to technological problems that arise in the hardware and software arts that underlie content management systems. Aspects of the present disclosure achieve performance and other improvements in peripheral technical fields including, but not limited to, using artificial intelligence agents to automate computer-implemented workflows and selecting an artificial intelligence agent.

Some embodiments include a sequence of instructions that are stored on a non-transitory computer readable medium. Such a sequence of instructions, when stored in memory and executed by one or more processors, causes the one or more processors to perform a set of acts for using AI responses to inform computer-implemented workflows.

Some embodiments include the aforementioned sequence of instructions that are stored in a memory, which memory is interfaced to one or more processors such that the one or more processors can execute the sequence of instructions to cause the one or more processors to implement acts for using AI responses to inform computer-implemented workflows.

In various embodiments, any combinations of any of the above can be organized to perform any variation of acts for using responses from an AI entity to automate workflow processing, and many such combinations of aspects of the above elements are contemplated.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure.

FIG. 1A exemplifies a system that uses responses from an AI entity to automate workflow processing in a content management system, according to an embodiment.

FIG. 1B1 depicts an example content management system workflow, according to an embodiment.

FIG. 1B2 depicts example workflow switch processing techniques as used in systems that use responses from an AI entity to inform a workflow switch, according to an embodiment.

FIG. 1C1 depicts an example AI question codification technique as used in systems that generate a document based on AI entity responses to AI questions that are prepositioned in a document template, according to an embodiment.

FIG. 1C2 depicts an example AI-informed template field processing technique as used in systems that generate a document based on AI entity responses to AI questions that are prepositioned as fields in a document template, according to an embodiment.

FIG. 2 depicts a flowchart that illustrates selected setup operations and selected ongoing operations, according to an embodiment.

FIG. 3 shows an example system partitioning of components that are interoperable so as to use responses from an AI entity to automate content management system workflow processing, according to an embodiment.

FIG. 4 shows several example prompt context generation techniques that are used in systems that use responses from an AI entity to automate workflow processing, according to an embodiment.

FIG. 5A shows several example metadata extraction techniques that are used in systems that use responses from an AI entity to automate workflow processing, according to an embodiment.

FIG. 5B shows an example contract generation technique as used in systems that include chained metadata, according to an embodiment.

FIG. 6A shows an example document template as deployed in systems that use responses from an AI entity to automate workflow processing, according to an embodiment.

FIG. 6B shows an example document template configuration user interface that is used in systems that use responses from an AI entity to automate workflow processing, according to an embodiment.

FIG. 7A, FIG. 7B and FIG. 7C present block diagrams of computing architectures having components suitable for implementing embodiments of the present disclosure and/or for use in the herein-described environments.

### DETAILED DESCRIPTION

Aspects of the present disclosure solve problems associated with using computer systems for eliminating the need for human intervention during processing of computer-implemented workflows. These problems are unique to, and may have been created by, various computer-implemented methods for eliminating the need for human intervention during processing of computer-implemented workflows in the context of content management systems. Some embodiments are directed to approaches for using AI responses to inform computer-implemented workflows. The accompanying figures and discussions herein present example environments, systems, methods, and computer program products for using responses from an AI entity to automate workflow processing.

As detailed in the foregoing, the problem to be solved is rooted in various technological limitations of legacy approaches. Improved technologies are needed. In particular, improved applications of technologies are needed to address the aforementioned technological limitations of legacy approaches. Examples of such technologies are presented infra with respect to the figures.

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

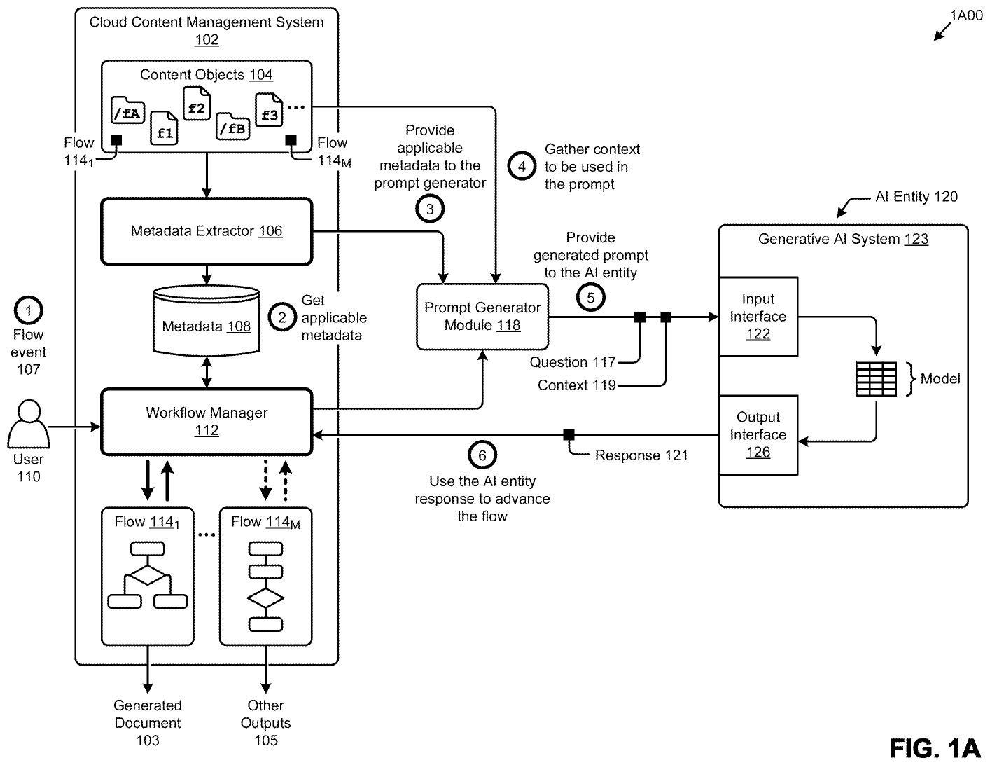

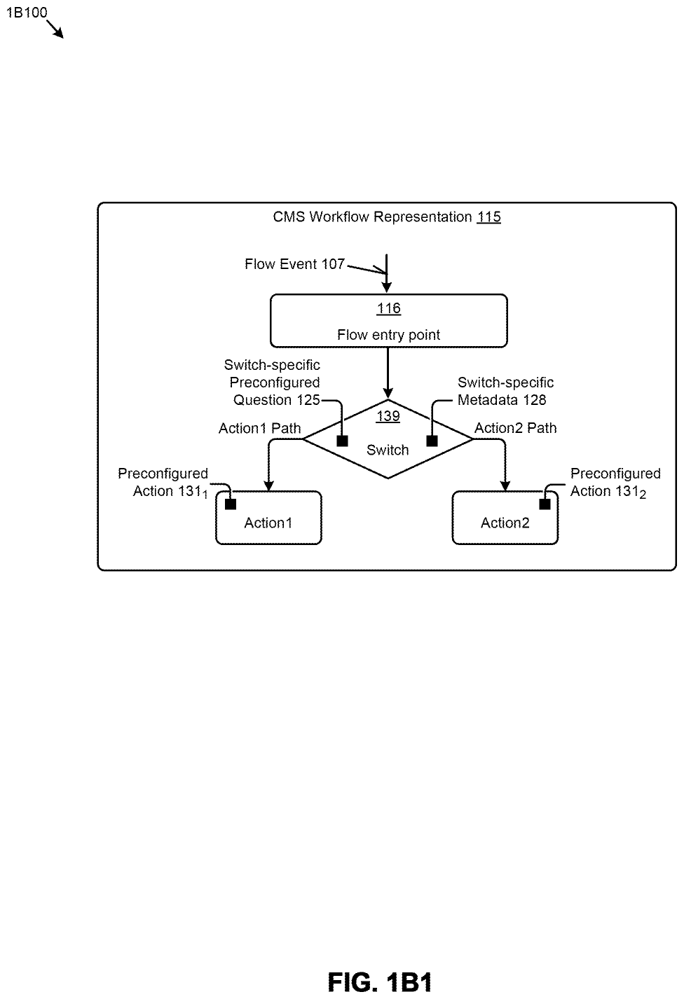

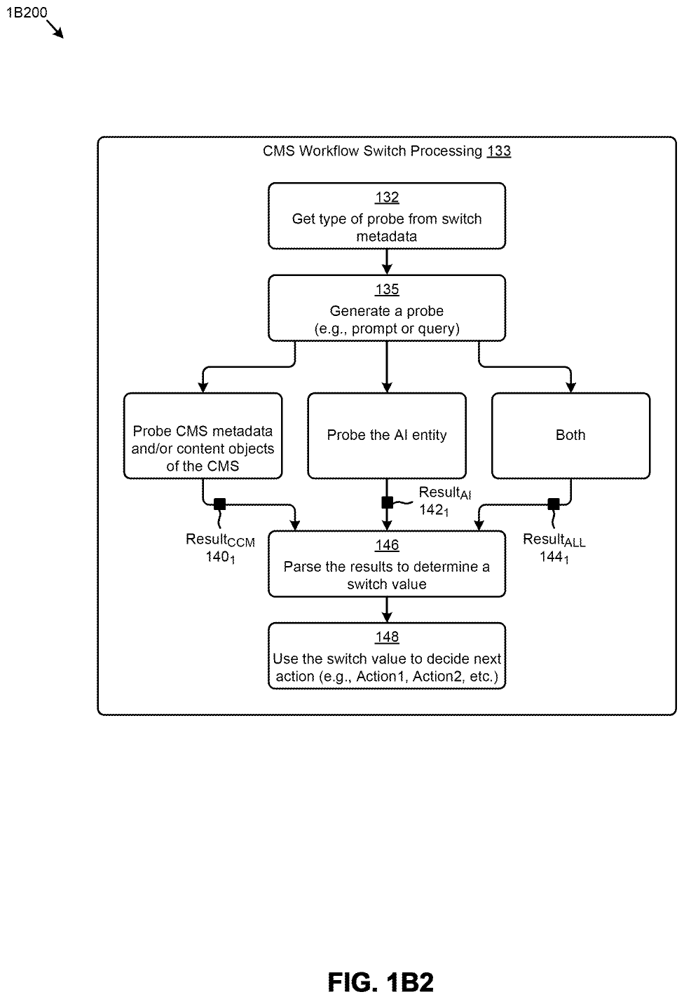

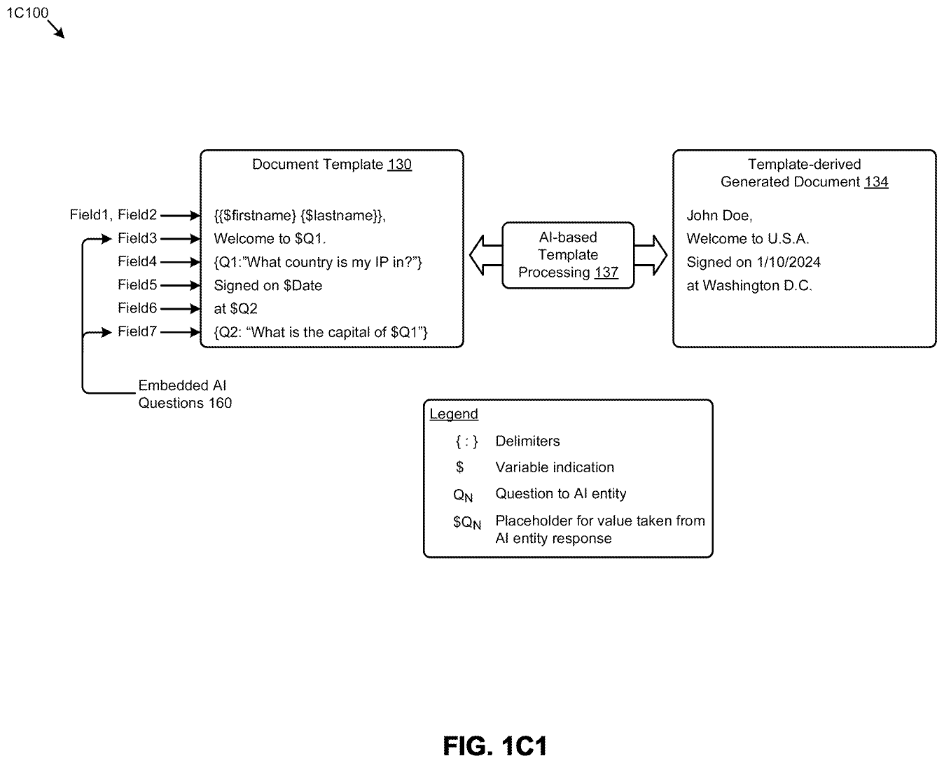

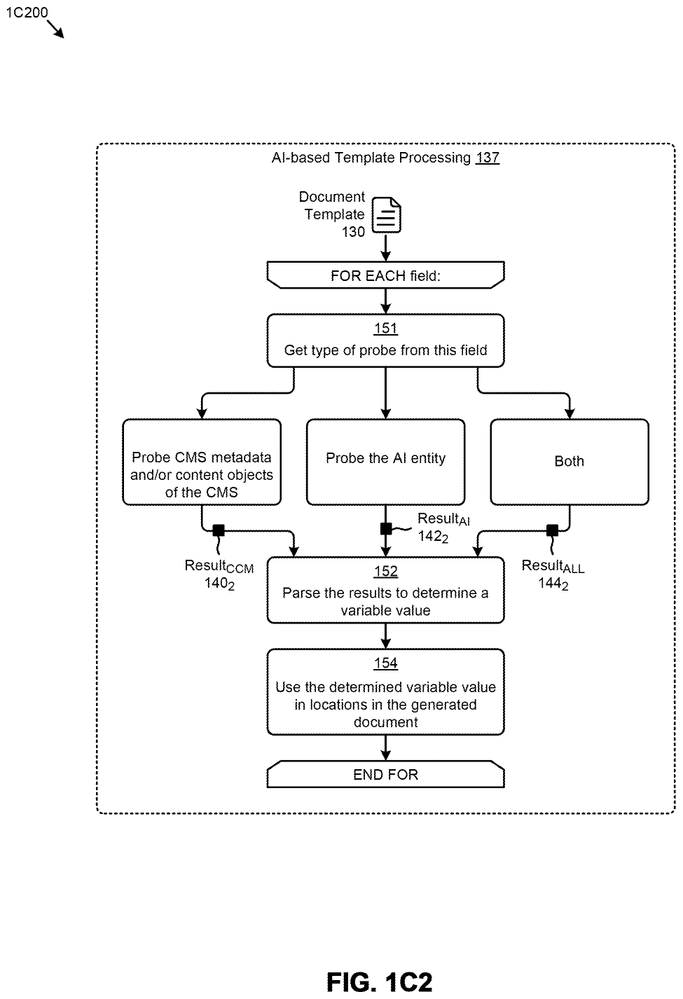

FIG. 1A exemplifies a system that uses responses from an AI entity to automate workflow processing in a content management system. As an option, one or more variations of system 1A00 or any aspect thereof may be implemented in the context of the architecture and functionality of the embodiments described herein and/or in any environment.

The figure is being presented to illustrate one partitioning of the major components involved in using an AI entity 120 to automate workflow processing in a content management system. As shown, a content management system (CMS) (e.g., cloud content management system 102) stimulates an artificial intelligence (AI) entity (e.g., the shown generative AI system 123) through a prompt generator (e.g., via prompt generator module 118). The CMS might interact with the AI entity for many reasons, however for purposes of illustration, FIG. 1A depicts interactions that pertain to workflow processing.

To explain, when workflow manager 112 is processing a workflow (e.g., flow 114₁, flow 114_{M}), the workflow manager will gather information pertaining to the workflow (e.g., metadata 108 pertaining to a decision in a workflow of metadata pertaining to a variable value in a workflow). Any known technique for identifying pertinent metadata may be used, however in this example partitioning, the shown metadata extractor 106 accesses content objects 104 and processes particular files (e.g., file “f1”, file “f2”, file “f3”, etc.), folders (e.g., folder “/fA”, folder “/fB”, etc.) and other stored data (e.g., description and metadata of flow 114₁, . . . , description and metadata of flow 114_{M}, etc.) to gather metadata that is in turn used in the generation of a prompt.

Further details regarding extraction and use of metadata are described in U.S. Patent Application Publication No. 2020/0065313, titled, “EXTENSIBLE CONTENT OBJECT METADATA”, published on Feb. 27, 2020, which is hereby incorporated by reference in its entirety.

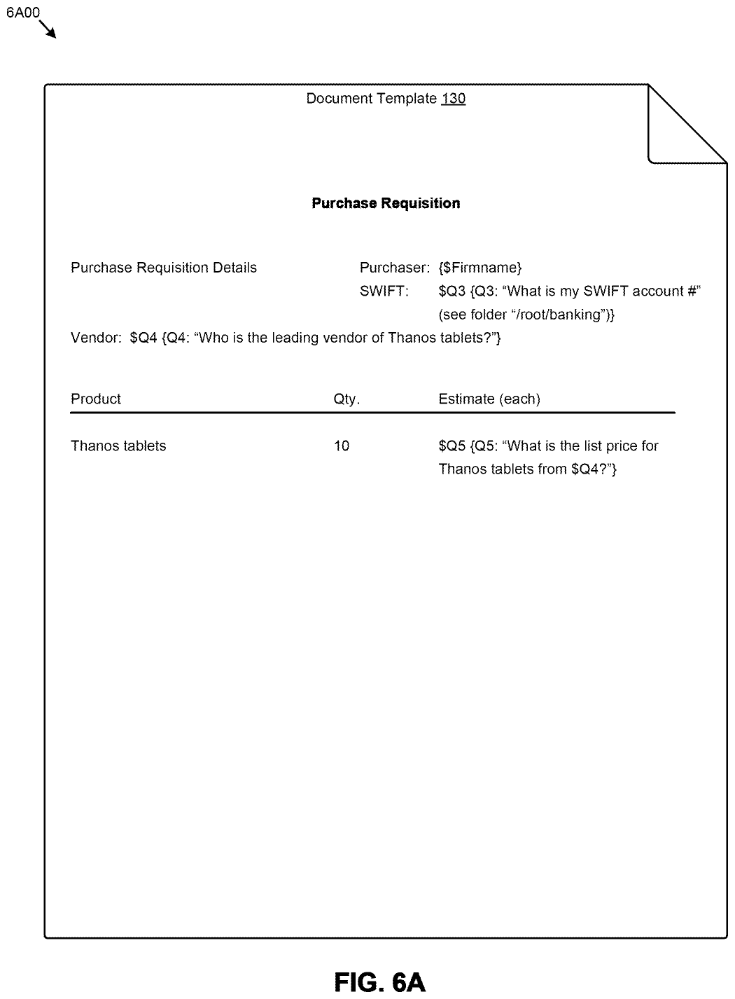

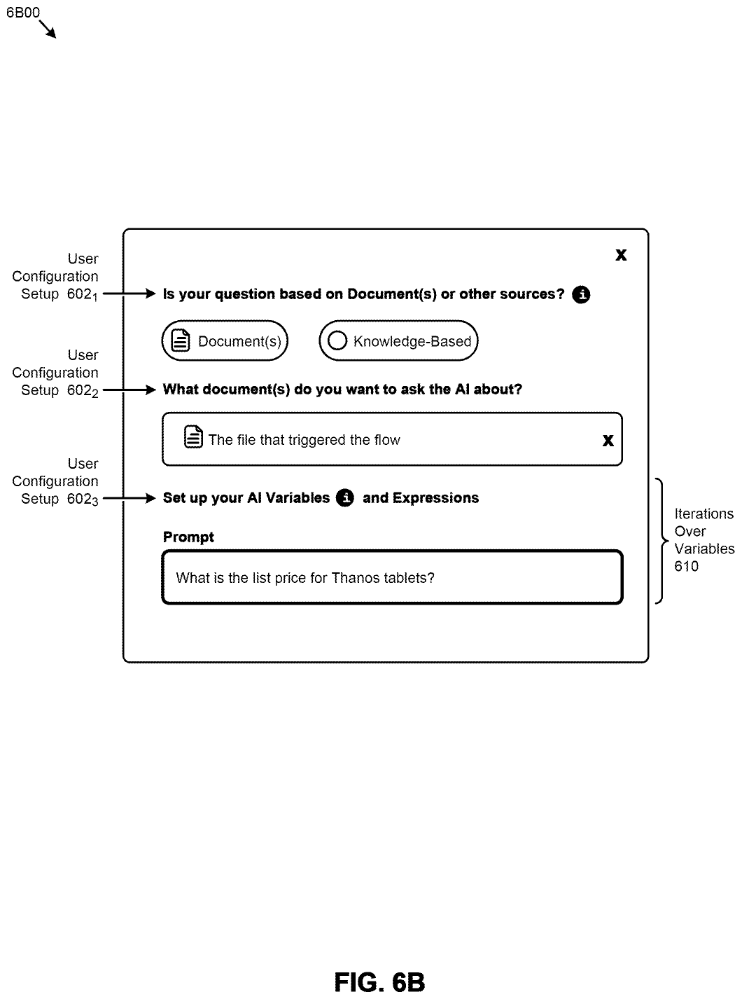

Now, referring to specific outcomes of this system 1A00, in addition to controlling progression through a workflow, system 1A00 is configured to avail itself of the AI entity when generating a document. That is, the AI entity might be prompted to return information that is, in turn, used as content in a generated document. In some cases, the AI-generated content, or portions therefrom, corresponds to a portion of a document template. Various techniques for obtaining AI generated content based on a document template is shown and described infra as pertains to FIG. 1C1, FIG. 1C2, FIG. 6A, and FIG. 6B.

Now, having an understanding of the functions of the individual components of the system of FIG. 1A, it can be seen that the system is configured (and can be further configured) to carry out a series of operations, the performance of which operations result in output of a generated document 103 as well as other outputs 105. To more fully explain, operation by operation, consider that at some moment in time a flow event 107 is raised (operation 1). Such a flow event can be raised in response to an action by user 110, or such a flow event can be raised by any processing within or through the cloud content management system (CCM). At some point, the existence of the flow event, plus any metadata associated with the flow event, is received at workflow manager 112. In this example, the workflow manager correlates the event (e.g., possibly based on the configuration of a decision or operation in a workflow) to some reason to stimulate the AI entity.

For example, a particular workflow might be configured to stimulate an AI entity with a question encountered in a workflow, and then to use all or portions of the AI entity's response as content for a generated document. In response to identification of a reason to stimulate the AI entity (e.g., a question being encountered in a workflow), any applicable metadata is gathered (operation 2) and the metadata is in turn provided to a prompt generator (operation 3). The prompt generator gathers context to be used in a prompt (operation 4).

Such context might be in the form of additional metadata and/or corresponding metadata values (e.g., as extracted by the shown metadata extractor 106), and/or such context might be in the form of natural language representation of an event or event sequence, and/or such context might be in the form of natural language representation of the actual contents of content objects 104. Given such context, the prompt generator provides a generated prompt to the AI entity (operation 5). In this particular example, the generated prompt is composed of natural language text of an inquiry (e.g., question 117), together with context (e.g., context 119) pertaining to the inquiry. As is known in the art, a prompt can be provided to an AI entity using a hypertext transport protocol (HTTP), or a prompt can be provided to an AI entity using application programming interfaces (APIs).

In this particular embodiment the interactions with the AI entity are agnostic to the particular mechanism used. As shown, a generic instance of an input interface 122 is provided. Similarly, a generic instance of an output interface 126 is provided to be able to transport any number of responses (e.g., response 121) from the AI entity back to the CCM, whereafter the CCM parses the response and uses aspects of the response to advance the subject workflow (operation 6).

The foregoing written description pertains to merely one possible embodiment and/or way to configure system 1A00 so as to facilitate advancing through a CMS workflow. Many variations are possible. In particular there are many ways to represent and/or to configure and/or to advance a CMS workflow. One example of a CMS workflow is shown and described as pertains to FIG. 1B1.

FIG. 1B1 depicts an example content management system workflow. As an option, one or more variations of content management system workflow 1B100 or any aspect thereof may be implemented in the context of the architecture and functionality of the embodiments described herein and/or in any environment.

The figure is being presented to illustrate one possible way to represent a workflow. More specifically, the presented CMS workflow representation 115 has an entry point capability (e.g., depicted by flow entry point 116), a decision-making capability (e.g., depicted by switch 139), and a plurality of preconfigured actions (e.g., depicted by preconfigured action 131₁ and by preconfigured action 131₂). In this particular representation, the workflow is invoked by an event (e.g., flow event 107), however there can be any other or different signaling (e.g., an API call) that results in invocation of a workflow at any particular location of the flow. More particularly, a workflow, or a portion of a workflow can be invoked at any location of the flow. In some cases, such a location may coincide with a workflow entry point, or such a location may coincide with a workflow decision, or such a location may coincide with a workflow action.

It now becomes apparent to one of ordinary skill in the art that any one or more of, (1) raising a flow event, and/or (2) enriching a decision-making capability, and/or (3) taking a next action of a workflow can be based in whole or in part on information coming back from an AI entity. Of particular interest in this section of this disclosure is how a prompt can be generated using a switch-specific preconfigured question 125 and/or corresponding switch-specific metadata 128, as well as how information coming back from an AI entity can influence any decision-making capabilities of the workflow (e.g., as implemented by one or more workflow switches). Accordingly, presented hereunder is a technique for AI-informed workflow switch processing.

FIG. 1B2 depicts example workflow switch processing techniques as used in systems that use responses from an AI entity to inform a workflow switch. As an option, one or more variations of workflow switch processing techniques 1B200 or any aspect thereof may be implemented in the context of the architecture and functionality of the embodiments described herein and/or in any environment.

The figure is being presented to explain with particularity how a workflow switch can itself be configured with sufficient information to initiate prompt generation as well as how a workflow switch can be configured to proceed to some next action based on results of one or more probes (e.g., a probe to an AI entity and/or a probe into a content object of the CMS).

The specific embodiment of CMS workflow switch processing 133 commences by determining (e.g., at step 132) the type(s) of probe(s) that are configured into the switch. Then, based at least in part on that determination, generating a probe (e.g., at step 135). As discussed here, a probe can be a database query to CMS data, or a probe can be a question or prompt to the AI entity. In some cases both types of probes are used. In some cases results from a database query over data or metadata of the CMS (e.g., result_{CCM} 140₁ is used to formulate a prompt to the AI entity. For example, various information embedded within results of a query that is formulated to return information-laden paragraphs of a template might be used as context when probing the AI entity.

There are other cases where results coming back from a prompt to the AI entity (e.g., result_{AI} 142₁) are used to formulate a database query. Consider for example the case where results coming back from a prompt to the AI entity offer some options, but the results coming back from the prompt to the AI entity does not offer rank the options. In such cases, the options given in the results can be used to formulate a query that is evaluated over one or more datasets of the CCM. Consider another case where results coming back from a prompt to the AI entity offer some information pertaining to (for example), the “number of brewers in Germany”, but the results coming back from the prompt to the AI entity does not offer the actual count of the number “of brewers in Germany”. In such a case, the partially-answered question given or implied in the results can be used to formulate a query that is evaluated over one or more datasets of the CCM.

Furthermore, there are situations where results (e.g., result_{ALL} 144₁) from both the AI entity as well as results from a CCM query are parsed, either separately or in combination (step 146) and then combined in a manner such that a switch value is provided by, or can be derived from or calculated from, the combination. The switch value in turn is used to steer execution toward one or more pre-defined actions (e.g., Action1, Action2, of step 148, etc.).

Although FIG. 1B2 as well as FIG. 1B1 depict only two paths that are possible from the switch (e.g., a leftward path action and a rightward path action), a switch can have any number of choices based on any number of switch values. Moreover, the switch processing as discussed here pertaining to FIG. 1B2 as well as FIG. 1B1 might correspond to switch processing by third party. In fact, it can happen that the entire workflow or any portion therefrom can be hosted by a third party.

Further details regarding use of workflows that are hosted by a third party are described in U.S. Pat. No. 11,681,572, titled “EXTENSIBLE WORKFLOW ACCESS”, issued on Jun. 20, 2023, which is hereby incorporated by reference in its entirety.

The foregoing written description pertains to merely one possible embodiment and/or way to implement a workflow switch processing technique. Many variations are possible, for example, the workflow switch processing technique as comprehended in the foregoing can be implemented in any environment, one example of which is shown and described as pertains to the following figure. More specifically, workflow switch processing might be based on AI-provided answers to questions that were posed to an AI entity as a prompt. There are many ways to codify AI questions. Furthermore, there are many ways to embed AI questions into a document template. One example of such embedding of AI questions into a document template is shown and described as pertains to FIG. 1C1.

FIG. 1C1 depicts an example AI question codification technique as used in systems that generate a document based on AI entity responses to AI questions that are prepositioned in a document template. As an option, one or more variations of AI question codification technique 1C100 or any aspect thereof may be implemented in the context of the architecture and functionality of the embodiments described herein and/or in any environment.

The figure is being presented to illustrate how a document template 130 can be constructed to include embedded AI questions 160 that are particularly configured for presentation (e.g., in a prompt) to an AI entity. Strictly as an example, the figure further illustrates how the shown AI-based template processing 137 can result in a template-derived generated document 134.

In this example, the document template is composed of a series of fields, any/all of which inform contents of a to-be-constructed generated document. As shown, some of the aforementioned fields can contain embedded AI questions.

The AI-based template processing can be instanced in any location, including without limitation in a CCM, and/or including without limitation in computing infrastructure of a third party. In fact, many partitioning and processing variations are possible. For example, the AI-based template field processing as comprehended in the foregoing can be implemented in any environment, one example of which is shown and described as pertains to FIG. 1C2.

FIG. 1C2 depicts an example AI-informed template field processing technique as used in systems that generate a document based on AI entity responses to AI questions that are prepositioned as fields in a document template. As an option, one or more variations of AI-informed template field processing technique 1C200 or any aspect thereof may be implemented in the context of the architecture and functionality of the embodiments described herein and/or in any environment.

The figure is being presented to illustrate how one possible implementation of AI-informed template field processing can be performed. As shown, given an instance of a document template 130, each field within the document template is processed in a FOR EACH loop where, based on a probe type, the CMS and/or the AI entity is probed. Specifically and as shown, for each field, once a probe type is determined (step 151), the CMS and/or the AI entity is probed using specific information as found in the field itself. A field may contain or imply a simple probe (e.g., “Q1: What country is my IP in”), or may contain or imply a compound probe where the results of a first probe are used to formulate a second probe (e.g., “What is the capital of $Q1”). In this latter case where results of a first probe (e.g., the value $Q1) are used to formulate a second probe may imply that results from a CCM query (e.g., result_{CCM} 140₂) are used to probe the AI entity, which in turn returns a result (e.g., result_{AI} 142₂) that is (or can be parsed so as to determine) a variable value (step 152). In some cases, progression through AI-based template processing 137 generates a variable value (e.g., result_{ALL} 1442) that is a derivative (or amalgamation) of results from a CCM query in combination with results from the AI entity. The determined variable value can then be used (e.g., step 154) in various locations of the generated document. As shown, this processing is carried out in a loop over any/all fields of a document template.

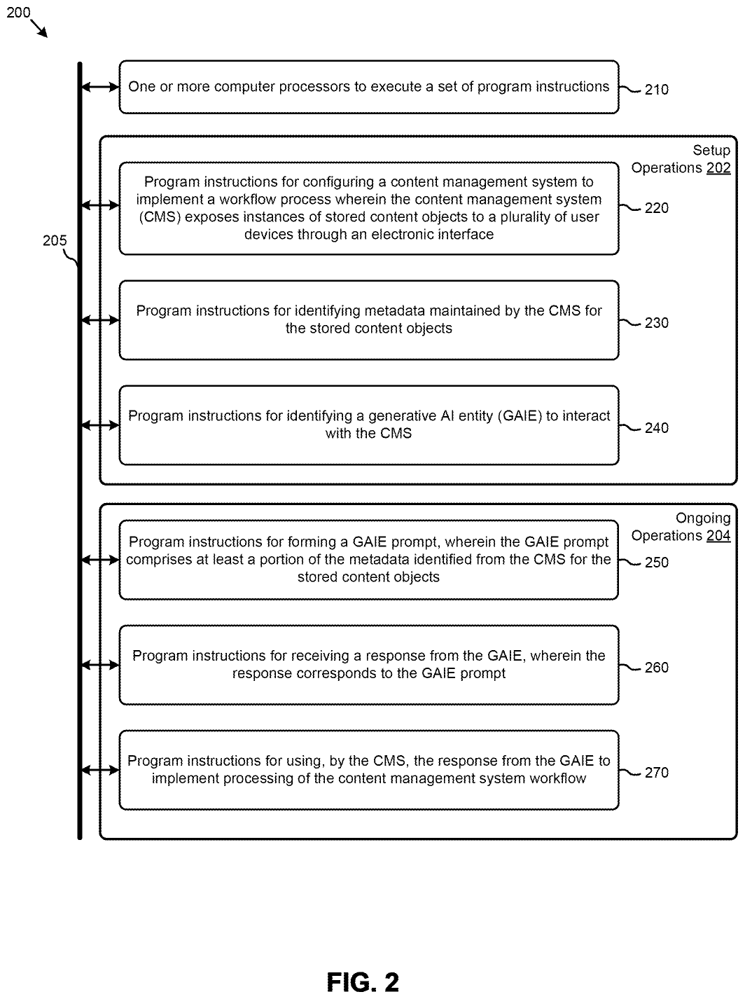

FIG. 2 depicts a flowchart that illustrates a system having setup operations and ongoing operations. As an option, one or more variations of system 200 or any aspect thereof may be implemented in the context of the architecture and functionality of the embodiments described herein and/or in any environment.

The figure is being presented to illustrate how a set of modules might be configured to implement setup operations 202 and ongoing operations 204 so as to implement embodiments of the herein-disclosed techniques. As shown, system 200 comprises a processor and a memory, the memory serving to store program instructions corresponding to the operations of the system. An operation can be implemented in whole or in part using program instructions accessible by a module. The shown modules are connected to a communication path 205, and any operation of any module can communicate with any other operations of other modules over communication path 205. Any operations performed within system 200 may be performed in any order unless as may be specified in the claims. The shown embodiment implements a portion of a computer system, presented as system 200, comprising one or more computer processors to execute a set of program code instructions (module 210) and modules for accessing memory to hold program code instructions to perform: configuring a content management system to implement a workflow process wherein the content management system (CMS) exposes instances of stored content objects to a plurality of user devices through an electronic interface (module 220); identifying metadata maintained by the CMS for the stored content objects (module 230); identifying a generative AI entity (GAIE) to interact with the CMS (module 240); forming a GAIE prompt, wherein the GAIE prompt comprises at least a portion of the metadata identified from the CMS for the stored content objects (module 250); receiving a response from the GAIE, wherein the response corresponds to the GAIE prompt (module 260); and using, by the CMS, the response from the GAIE to implement processing of the content management system workflow (module 270).

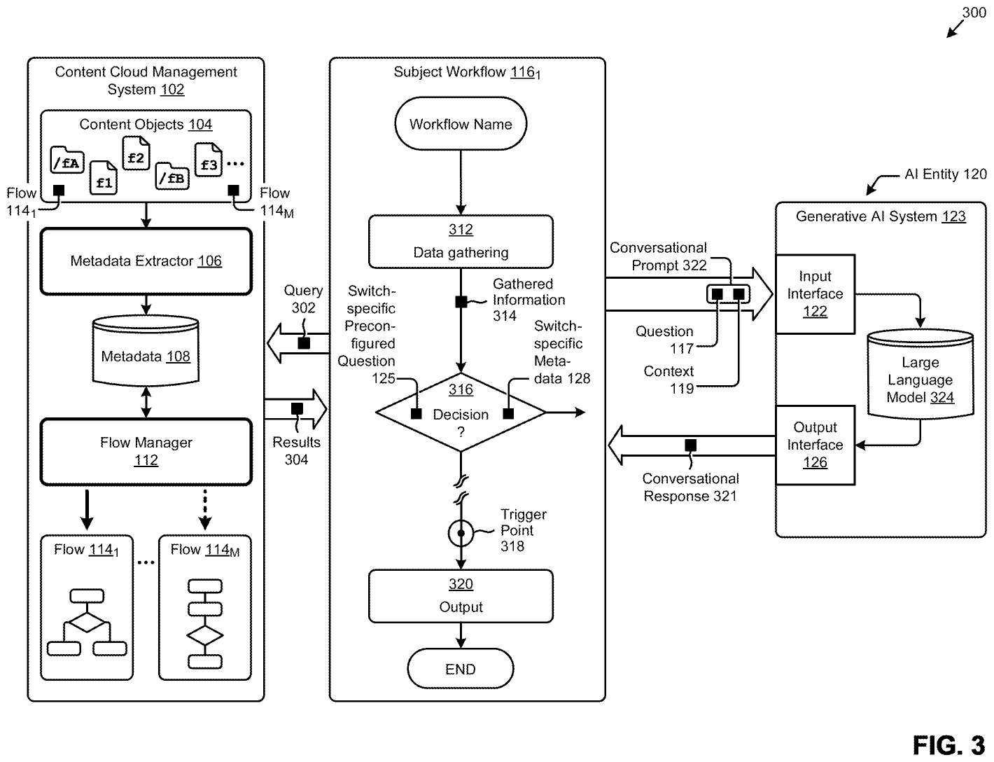

The foregoing pertains to merely one possible partitioning. Many variations are possible, for example, the flows and modules as comprehended in the foregoing can be implemented in any environment, and/or in accordance with any alternative partitioning of components, one example of which is shown and described as pertains to FIG. 3.

FIG. 3 shows an example system partitioning of components that are interoperable so as to use responses from an AI entity to automate content management system workflow processing. As an option, one or more variations of system partitioning 300 or any aspect thereof may be implemented in the context of the architecture and functionality of the embodiments described herein and/or in any environment.

Strictly for illustrative purposes, subject workflow 116₁ contains a compound probe where the results of a first probe are used to formulate a second probe. More specifically, subject workflow 116₁ contains a compound probe where the results (e.g., the shown results 304) of a query (e.g., query 302) over CCM data are used to formulate a second probe such as conversational prompt 322, which is submitted to generative AI system 123. As shown, providing such a conversational prompt to generative AI system 123 results in a generative AI system response (e.g., conversational response 321), which conversational response (or portions therefrom) can be used to inform a switch (e.g., decision 316) of a workflow, and/or which conversational response (or portions therefrom) can be used to trigger a subject workflow at some particular trigger point (e.g., trigger point 318). In this example, triggering the subject workflow at the aforementioned particular trigger point causes the subject workflow to produce an output (e.g., at step 320).

In many cases, a conversational response is parsed by a natural language processor (NLP). This is because, in many cases, the conversational response might contain conversational language (e.g., a complete sentence or several sentences) that includes the particular information sought. To illustrate, suppose that a particular preconfigured question 125 (e.g., of decision 316) is codified as, “What country is my IP in?” Then further suppose that a corresponding conversational response from the AI entity is, “According to WHOIS and other databases, your IP Address is: {IPv4: 76.176.136.76, IPv6: Not detected} and your ISP is ‘Charter Communications Inc’, of Sacramento, California, U.S.A. Do you need more information?” As can now be appreciated, the specific information expected to be returned by the AI entity based on the foregoing particular preconfigured question is simply, “America”. However natural language processing over the conversational response might isolate the “country” as “U.S.A.” This apparent mismatch, which is not wrong, but merely a mismatch of style or linguistic choices, can be ameliorated through use of compound questions that are formed in a similar fashion to the foregoing compound probes.

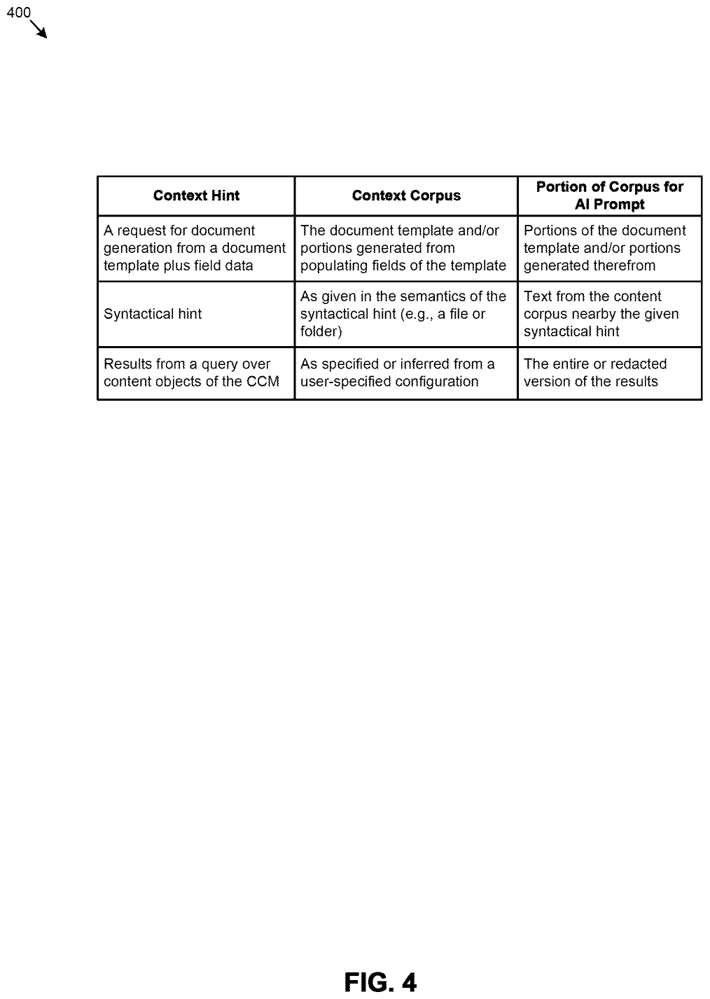

Those of ordinary skill in the art will recognize that the contents (e.g., degree of specificity, type of language, tone, etc.) of a conversational response as returned by an AI entity is dependent on the context given in the conversational prompt. Accordingly, to facilitate stimulating a generative AI system and, more particularly, to stimulate a large language model 324 with question 117 to be answered in some particular way, appropriate context (e.g., context 119) needs to be supplied in the conversational prompt. To this end and, more specifically, to facilitate construction of context for the conversational prompt, a workflow might be configured to assemble a corpus of gathered information 314, which might be gathered in a separate step (e.g., step 312) or, a workflow might be configured to retrieve gathered information that corresponds to results 304 of query 302. In fact, there are many techniques for a workflow to gather a corpus of information for a conversational prompt. Several example techniques are shown and described as pertains to FIG. 4.

FIG. 4 shows several example prompt context generation techniques that are used in systems that use responses from an AI entity to automate workflow processing. As an option, one or more variations of prompt context generation techniques 400 or any aspect thereof may be implemented in the context of the architecture and functionality of the embodiments described herein and/or in any environment.

The figure is being presented to illustrate how CMS and other gathered information can be used as context which in turn is provided in an engineered prompt to a generative AI system. More particularly, the figure is being presented to suggest how context hints that are present in a CMS can be used to identify applicable corpora, information from which corpora is in turn used in an engineered prompt.

FIG. 4 depicts several prompt context generation techniques 400, which are exemplified in the shown multi-column table. The columns refer to (1) a context hint (leftmost column), (2) a corresponding context corpus (middle column), and (3) a suggestion of what portion or portions of the corpus can be used in an engineered prompt (rightmost column).

In a simple example, selected merely for illustrative purposes, one or more context hints might derive from a request to generate a document from a template. For example, a request to generate a document from a template might comport with the semantics of, “Generate a Purchase Order for me based on my company's PO template and based on the product description reproduced herein.” In this example, the context can comprise: (1) information in the document template itself and/or (2) field data and/or information generated during the process of populating fields with field data.

In another example, a hint might be, or be based on, known syntax. For example, it can be assumed that a filename itself contains context that could be useful in forming an engineered prompt. To explain, the CMS will most certainly know the name of a subject file plus the pathname to the file. Accordingly, the filename and pathname can be assumed to provide context for an engineered prompt. Consider a file named “Proposal from Company X to Company Y” that is in a path having a folder called, “Proposals for On-site Service Provision”. In this case, all portions of the filename and all portions of the pathname can be used as context to be provided in an engineered prompt.

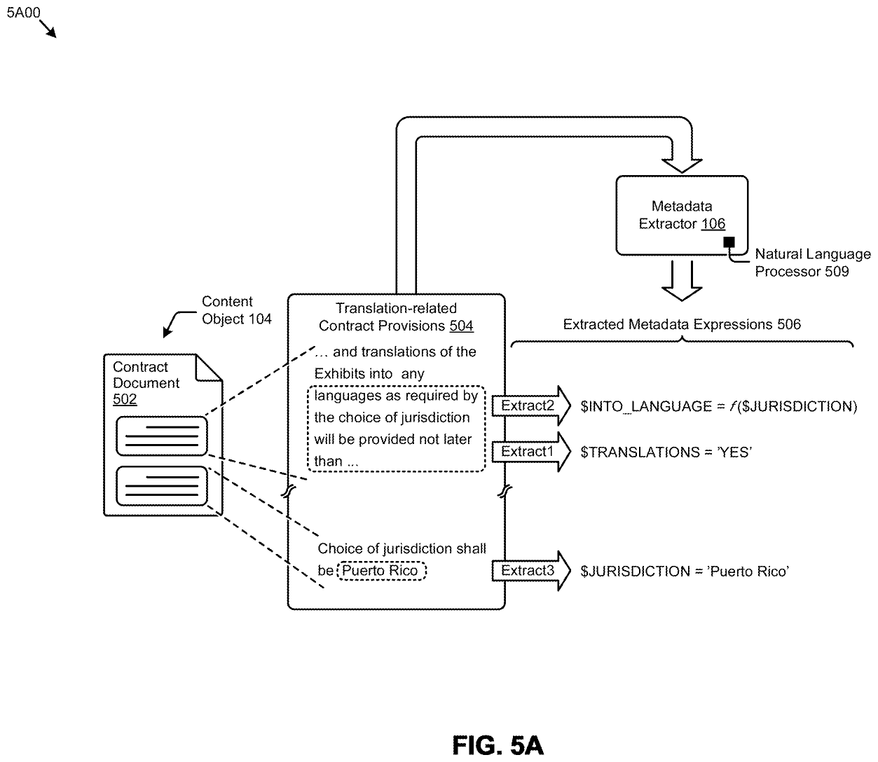

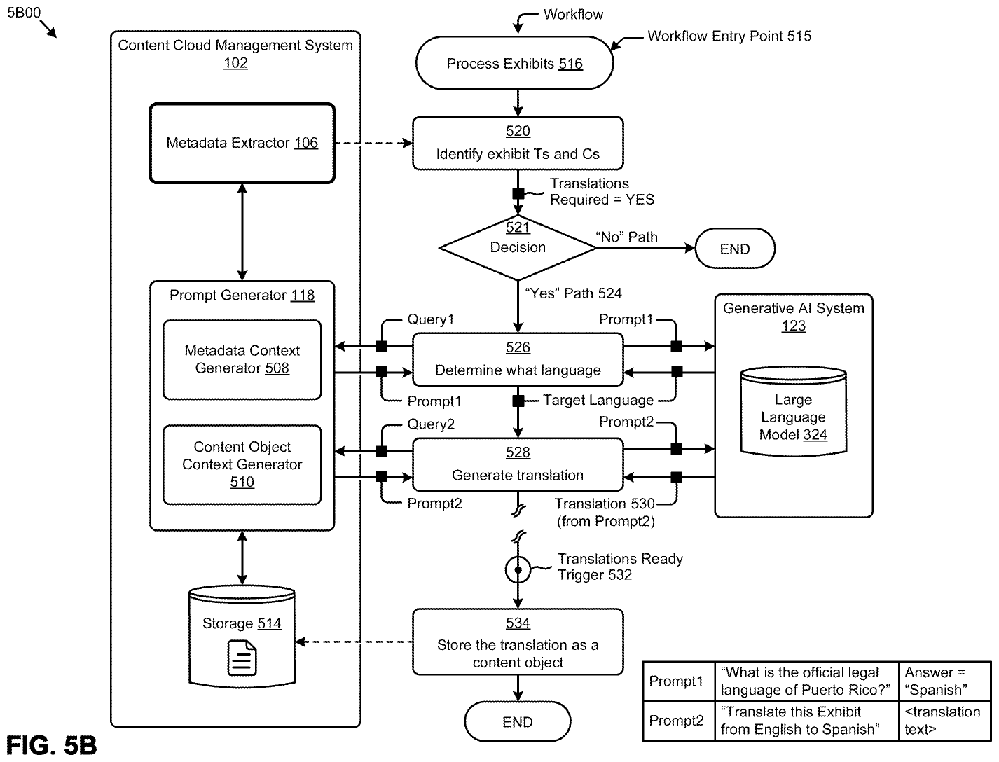

In addition to information encoded into a filename or pathname, certain content objects can be subjected to metadata extraction, and the metadata names and values can be used as context. An example of this follows as pertains to FIG. 5A and FIG. 5B.

FIG. 5A shows several example metadata extraction techniques that are used in systems that use responses from an AI entity to automate workflow processing. As an option, one or more variations of metadata extraction techniques 5A00 or any aspect thereof may be implemented in the context of the architecture and functionality of the embodiments described herein and/or in any environment.

As is known in the art, generative AI entities can be configured to be language independent. That is, if such a generative AI entity were trained using English language and French language documents, then a prompt in English would (most likely) produce results in English, whereas a prompt in French would (most likely) produce results in French. Accordingly, the language used to name metadata parameters and/or the language used in the value of the metadata parameter (e.g., a string value) can be used with a reasonable expectation that the generative AI entity would return rational (i.e., statistically accurate) responses.

As shown, the metadata extraction recognizes that indeed, this contract document 502 does contain provisions 504 pertaining to language, and more particularly that (1) language translations are required (i.e., corresponding to metadata Extract1, codified as “$TRANSLATIONS=‘YES’”), and also that (2) the language translation needed is a function of some particular identified jurisdiction (i.e., corresponding to metadata Extract3, codified as “$INTO_LANGUAGE=ƒ($JURISDICTION)”. In some cases, such as the foregoing “$INTO_LANGUAGE=ƒ($JURISDICTION)” metadata expression, the metadata expression syntax carries the semantics of a compound or chained metadata expression. That is, the metadata expression, “$INTO_LANGUAGE=ƒ($JURISDICTION)”, is chained in the sense that evaluation of the metadata expression depends on evaluation of a different metadata expression. In this case, the compound metadata expression, “$INTO_LANGUAGE=ƒ($JURISDICTION)” depends on the value of metadata expression of Extract3 (“$JURISDICTION”). Any known technique (e.g., using a natural language processor 509) can be used to parse and manipulate passages of the contract provisions into extracted metadata expressions 506 and corresponding value(s).

The foregoing written description pertains to merely one possible embodiment and/or way to implement various metadata extraction techniques. Many variations are possible. For example, the metadata extraction techniques as comprehended in the foregoing can be implemented in any environment, and/or used in any application (e.g., for AI-aided contract generation from a template), one example of which is shown and described as in FIG. 5B.

FIG. 5B shows an example contract generation technique as used in systems that include chained metadata. As an option, one or more variations of contract generation technique 5B00 or any aspect thereof may be implemented in the context of the architecture and functionality of the embodiments described herein and/or in any environment.

FIG. 5A pertains to how to extract metadata, whereas FIG. 5B pertains to how to use the extracted metadata when interacting with a generative AI system. More specifically, and continuing discussion of the example contract document presented in FIG. 5A, once metadata has been extracted, that metadata can be used in prompts to the generative AI system. The example of processing a contract document, including any exhibits, is presented merely as a illustration. Other documents and other document types can be advantageously processed using the techniques of FIG. 5A and FIG. 5B.

Now, referring to the specific example of the workflow of FIG. 5B, consider that there is a workflow entry point 515 that corresponds to a subflow to process exhibits (e.g., the shown step 516). This subflow can be entered at any point in time, possibly as a result of a higher level flow, or possibly as a result of the occurrence (e.g., saving) of a new contract document into the cloud content management system. As an initial operation of this subflow to process exhibits, step 520 serves to identify terms and conditions pertaining to exhibits. Continuing the example of FIG. 5A, this might entail checking for extracted metadata that corresponds to whether or not translations are required. To further explain this example, consider that translations are required (e.g., there is an occurrence of metadata “$TRANSLATIONS=‘YES’”) and, as such, decision 521 will take the “Yes” path 524, which leads to further processing of the required translation. In this example, it is axiomatic that the language of the translation must be determined (step 526) before prompting the AI entity to perform the translation (step 528).

As is known in the art, the syntax and semantics of a response from a generative AI system is dependent on the syntax and semantics of a prompt. Accordingly prompt engineering needs to be performed when asking the generative AI system to determine the target language into which the exhibit(s) is/are to be translated. Furthermore, prompt engineering needs to be performed when asking the generative AI system to perform the translation of the exhibit(s). This particular implementation relies on step 526 to determine what language, and this particular implementation relies on step 528 to actually generate the translation. To further explain, step 526 sends the shown query1 to prompt generator module 118. The prompt generator in turn invokes metadata context generator 508 and/or content object context generator 510, so as to cause the prompt generator to return prompt1 corresponding to query1. Prompt1 is then presented to the generative AI system with the expectation that the generative AI system will be able to determine the target language. In this example, the target language is the official language used in the jurisdiction of Puerto Rico, which can be answered by the generative AI system in response to the prompt, “What is the official legal language of Puerto Rico”.

Now, having knowledge of the target language, step 528 serves to generate a prompt that provides enough context for the generative AI system to generate the translation. As shown, step 528 sends query2 to prompt generator module 118. The prompt generator in turn invokes metadata context generator 508 and/or content object context generator 510, so as to cause the prompt generator to return prompt2 corresponding to query2. Prompt2 is then presented to the generative AI system with the expectation that the generative AI system will be able to produce a translation 530 that is translated into the target language. In this case, the context of prompt2 (“Translate this Exhibit from English to Spanish”) includes the original language of the subject exhibit (“English”), and possibly some formatting information. For example, prompt2 might specify that the translation should be provided in some particular format (e.g., “HTML”, “XML”, etc.).

As shown, the foregoing interaction with the generative AI system can be carried out synchronously or asynchronously. Moreover, the workflow can be constructed such that the workflow has an asynchronous entry point that is triggered when the translation or translations are ready (e.g., translations ready trigger 532). When the translation(s) are ready, then step 534 serves to store the translations(s) as a content object into storage 514.

The foregoing written description pertains to merely one possible embodiment and/or way to process a contract document. Many variations are possible, for example, the contract processing as comprehended in FIG. 5A and FIG. 5B could possibly rely on, at least in part, a document template. In fact, document templates can be constructed to include a significant amount of context used in prompt generation.

FIG. 6A shows an example document template as deployed in systems that use responses from an AI entity to automate workflow processing. As an option, one or more variations of document template 6A00 or any aspect thereof may be implemented in the context of the architecture and functionality of the embodiments described herein and/or in any environment.

The figure is being presented to illustrate how document templates can be constructed to include a significant amount of context used in prompt generation. More particularly, the figure is being presented to illustrate how a document template can be created to address many practical use cases. In this specific example, the use case corresponds to CMS- and AI-assisted generation of a “Purchase Requisition” document. As will become clear from the discussion below, a document template can contain any combination of inline text (e.g., text that is to be output into a generated document) and inline metadata (e.g., expressions that evaluate to text that is to be output into a generated document). In this example, the relative position (e.g., reading order) of the inline text and the inline metadata is defined purposely to comport with some desired layout of a generated document. Furthermore, in this example, the formatting (e.g., spacing, typeface, tables, rule lines, etc.) of the inline text and the inline metadata is defined purposely to comport with some desired ‘look-and-feel’ of a generated document.

The syntax use in this example is as follows: (1) a dollar sign is used preceding a name, (2) a parenthesized or brace-enclosed expression that follows a name is a candidate for the content of a prompt, and (3) portions of a parenthesized or brace-enclosed expression can be included expressly to make it easier to identify an answer returned by an AI entity. In this specific type of template deployment, portions of the parenthesized or brace-enclosed expressions are questions that have singular unambiguous answers, such as “What is my SWIFT account #”. In some cases, portions of the parenthesized or brace-enclosed expressions contain hints and/or are hints that are in a form to be provided to a data gathering facility (e.g., referring to the data gathering step 312 of FIG. 3).

Nearly unlimited variations of document template configurations are possible. For example, the document template as comprehended in the foregoing can be configured for any purpose, using any combination of inline text and inline expressions, and/or can be implemented in any environment. Moreover, a document template such as depicted in FIG. 6A can be constructed manually, and/or can be constructed with the aid of document template configuration user interfaces. More particularly, a particular document template configuration user interface might be specifically configured to aid a user in forming an inline expression. One of ordinary skill in the art will appreciate that use of a particularly configured user interface serves not only to aid a user in forming an inline expression, but also serves the purpose of standardizing on a particular syntax of the inline expressions.

In the context of deployments that are integrated into or alongside of a CMS, there is a wealth of information available that is at least potentially useful as prompt context when interacting with an AI entity. A document template configuration user interface such as is depicted in FIG. 6B serves to aid the user in identifying information that the user deems to be particularly useful for interacting with an AI entity. For example, the shown document template configuration user interface suggests different corpora of information, specifically, information to be derived from the contents of a content object of the CMS or information to be derived from an AI entity.

FIG. 6B shows an example document template configuration user interface that is used in systems that use responses from an AI entity to automate workflow processing. As an option, one or more variations of document template configuration user interface 6B00 or any aspect thereof may be implemented in the context of the architecture and functionality of the embodiments described herein and/or in any environment.

The figure is being presented to illustrate how a document template might be configured through use of a computerized graphical user interface (GUI). As shown, document template configuration user interface 6B00 includes screen devices that support (1) user identification of question sources (e.g., user configuration setup 6021); (2) user identification of documents (e.g., the file that triggered the flow), the contents of which are to be provided to the AI entity (e.g., user configuration setup 6022); and (3) user establishment of variables and expressions (e.g., user configuration setup 6023). Although the shown example depicts only one screen device for user establishment of variables and expressions, there can be any number of screen devices corresponding to any number of variables and expressions. Such screen devices can be presented in a user interface in a scrolling region, or can be presented sequentially (e.g., via iterations over variables 610).

The shown document template configuration user interface suggests different corpora of information, specifically, information to be derived from the contents of a content object of the CMS (e.g., corresponding to the shown “Documents” button) or information to be derived from an AI entity (e.g., corresponding to the shown “Knowledge-Based” button.

### Other Embodiments

Although the foregoing disclosure relates substantially to the shown illustrative examples, there are many situations where information returned by the AI entity can be used in a document. Moreover an AI entity can be prompted in a manner that requires/requests the AI entity to produce responses in a prosaic form. For example, an AI entity can be prompted to provide a “summary” of the human readable portions of the content object. Additionally or alternatively, an AI entity can be prompted to identify specific words, phrases, or other aspects of a content object using highlighting, bolding, etc.

For example, given a content object an AI entity can be asked to isolate one or more specific items of information. Strictly as examples, given an SEC filing, the AI entity can be asked to isolate quarterly results, policy descriptions and/or policy violations, etc. In fact, an AI entity can be asked to format content in a particular manner. For example, the AI entity might be asked to reformat an AI-generated summary into a blog post.

Additionally or alternatively, the AI entity can be asked to generate a summary of the contents of a particular folder. In some cases all or portions of a AI-generated summary is used in a further prompt in expectation of receiving a second response from the AI entity. Still further, given a content object that is a contract document, an AI entity can be asked to isolate one or more of, a total contract value, a list of signatories, choice of law, titles of exhibits, etc.

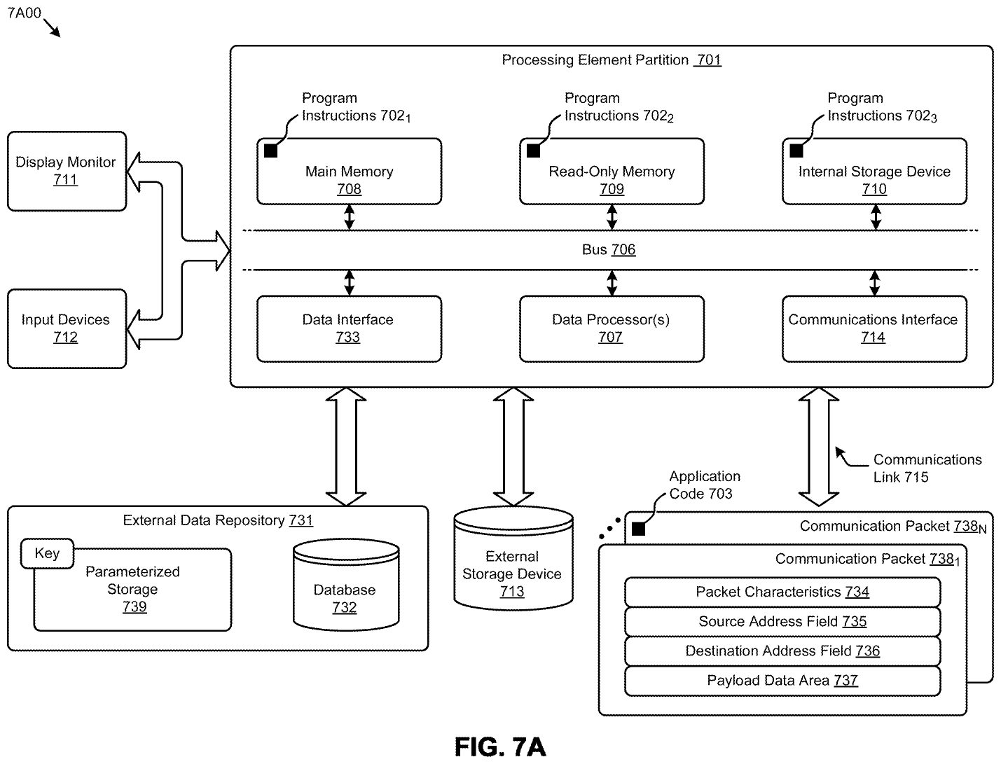

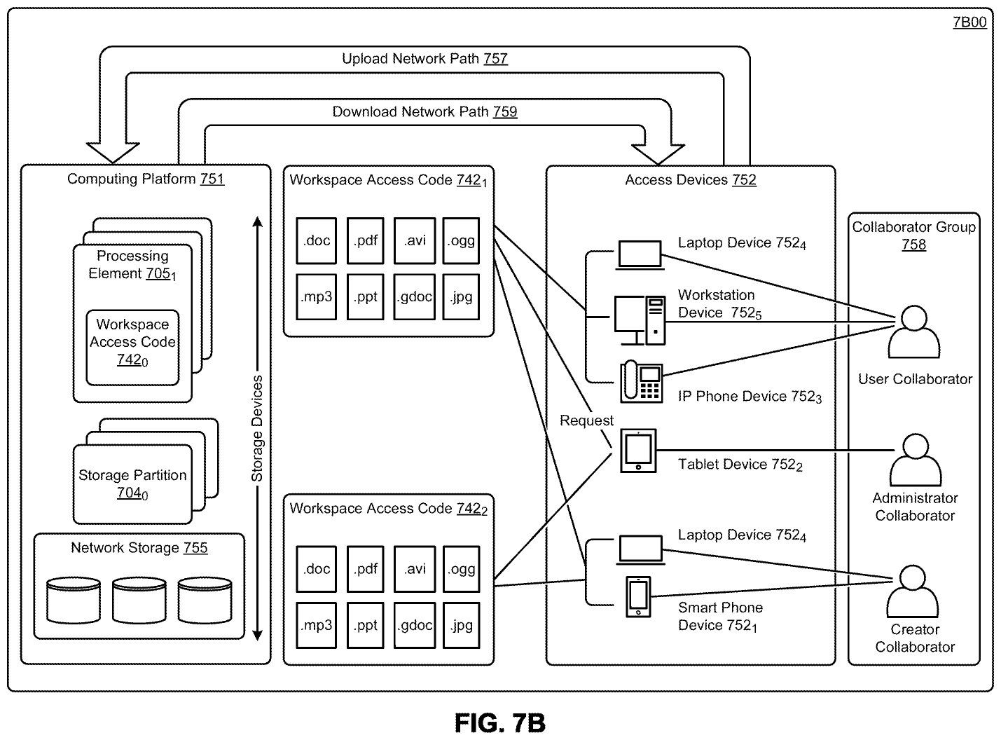

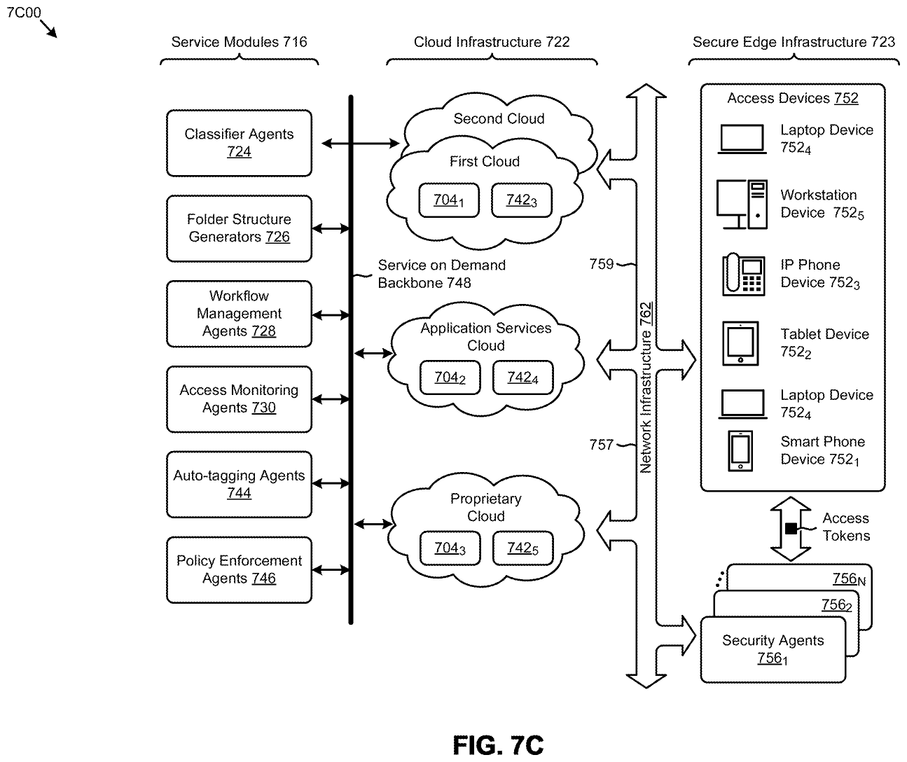

Any or all of the foregoing computer-implemented techniques can be implemented in a computer system such as is shown and described as pertains to FIG. 7A, FIG. 7B. and/or FIG. 7C.

### System Architecture Overview

### Additional System Architecture Examples

FIG. 7A depicts a block diagram of an instance of computer system 7A00 suitable for implementing embodiments of the present disclosure. Computer system 7A00 includes a bus 706 or other communication mechanism for communicating information. The bus interconnects subsystems and devices such as a central processing unit (CPU), or a multi-core CPU (e.g., data processor 707), a system memory (e.g., main memory 708, or an area of random access memory (RAM)), a non-volatile storage device or non-volatile storage area (e.g., read-only memory 709), an internal storage device 710 or external storage device 713 (e.g., magnetic or optical), a data interface 733, a communications interface 714 (e.g., PHY, MAC, Ethernet interface, modem, etc.). The aforementioned components are shown within processing element partition 701, however other partitions are possible. Computer system 7A00 further comprises a display 711 (e.g., CRT or LCD), various input devices 712 (e.g., keyboard, cursor control), and an external data repository 731.

According to an embodiment of the disclosure, computer system 7A00 performs specific operations by data processor 707 executing one or more sequences of one or more program instructions contained in a memory. Such instructions (e.g., program instructions 702₁, program instructions 702₂, program instructions 702₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 7A00 performs specific networking operations using one or more instances of communications interface 714. Instances of communications interface 714 may comprise one or more networking ports that are configurable (e.g., pertaining to speed, protocol, physical layer characteristics, media access characteristics, etc.) and any particular instance of communications interface 714 or port thereto can be configured differently from any other particular instance. Portions of a communication protocol can be carried out in whole or in part by any instance of communications interface 714, and data (e.g., packets, data structures, bit fields, etc.) can be positioned in storage locations within communications interface 714, or within system memory, and such data can be accessed (e.g., using random access addressing, or using direct memory access DMA, etc.) by devices such as data processor 707.

Communications link 715 can be configured to transmit (e.g., send, receive, signal, etc.) any types of communications packets (e.g., communication packet 738₁, communication packet 738_{N}) comprising any organization of data items. The data items can comprise a payload data area 737, a destination address 736 (e.g., a destination IP address), a source address 735 (e.g., a source IP address), and can include various encodings or formatting of bit fields to populate packet characteristics 734. In some cases, the packet characteristics include a version identifier, a packet or payload length, a traffic class, a flow label, etc. In some cases, payload data area 737 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 707 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 731, which in turn can be formatted into any one or more storage areas, and which can comprise parameterized storage 739 accessible by a key (e.g., filename, table name, block address, offset address, etc.).

Execution of the sequences of instructions to practice certain embodiments of the disclosure are performed by a single instance of computer system 7A00. According to certain embodiments of the disclosure, two or more instances of computer system 7A00 coupled by a communications link 715 (e.g., LAN, public switched telephone network, or wireless network) may perform the sequence of instructions required to practice embodiments of the disclosure using two or more instances of components of computer system 7A00.

Computer system 7A00 may transmit and receive messages such as data and/or instructions organized into a data structure (e.g., communications packets). The data structure can include program instructions (e.g., application code 703), communicated through communications link 715 and communications interface 714. Received program instructions may be executed by data processor 707 as it is received and/or stored in the shown storage device or in or upon any other non-volatile storage for later execution. Computer system 7A00 may communicate through a data interface 733 to a database 732 on an external data repository 731. Data items in a database can be accessed using a primary key (e.g., a relational database primary key).

Processing element partition 701 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 707. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to defining a security perimeter based on content management system observations of user behavior. A module may include one or more state machines and/or combinational logic used to implement or facilitate the operational and/or performance characteristics pertaining to defining and/or sharing a security perimeter based on content management system observations of user behavior.

Various implementations of database 732 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of defining and sharing a security perimeter based on content management system observations of user behavior). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to defining and sharing a security perimeter based on content management system observations of user behavior, and/or for improving the way data is manipulated when performing computerized operations pertaining to continuously updating content object-specific risk assessments.

FIG. 7B depicts a block diagram of an instance of cloud-based environment 7B00. Such a cloud-based environment supports access to workspaces through the execution of workspace access code (e.g., workspace access code 742₀, workspace access code 742₁, and workspace access code 742₂). Workspace access code can be executed on any of access devices 752 (e.g., laptop device 752₄, workstation device 752₅, IP phone device 752₃, tablet device 752₂, smart phone device 752₁, etc.), and can be configured to access any type of object. Strictly as examples, such objects can be folders or directories or can be files of any filetype. The files or folders or directories can be organized into any hierarchy. Any type of object can comprise or be associated with access permissions. The access permissions in turn may correspond to different actions to be taken over the object. Strictly as one example, a first permission (e.g., PREVIEW_ONLY) may be associated with a first action (e.g., preview), while a second permission (e.g., READ) may be associated with a second action (e.g., download), etc. Furthermore, permissions may be associated to or with any particular user or any particular group of users.

A group of users can form a collaborator group 758, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 751, including in a middleware setting. As shown, a portion of the workspace access code resides in and can be executed on one or more processing elements (e.g., processing element 705₁). The workspace access code can interface with storage devices such as networked storage 755. Storage of workspaces and/or any constituent files or objects, and/or any other code or scripts or data can be stored in any one or more storage partitions (e.g., storage partition 704₀). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 757). A stored workspace can be delivered to a particular user and/or shared with other particular users via a download (e.g., a download from a processing element to an access device over a download network path 759).

FIG. 7C depicts a block diagram of an instance of cloud-based computing system 7C00 suitable for implementing embodiments of the present disclosure. More particularly, the cloud-based computing system is suitable for implementing a cloud content management system, which cloud-based computing system is sometimes known as a cloud content manager (CCM).

The figure shows multiple variations of cloud implementations that embody or support a CCM. Specifically, public clouds (e.g., a first cloud and a second cloud) are intermixed with non-public clouds (e.g., the shown application services cloud and a proprietary cloud). Any and/or all of the clouds can support cloud-based storage (e.g., storage partition 704₁, storage partition 704₂, storage partition 704₃) as well as access device interface code (workspace code 742₃, workspace code 742₄, workspace code 742₅).

The clouds are interfaced to network infrastructure 762, which provides connectivity between any/all of the clouds and any/all of the access devices 752. More particularly, any constituents of the cloud infrastructure 722 can interface with any constituents of the secure edge infrastructure 723 (e.g., by communicating over the network infrastructure). The aforementioned access devices can communicate over the network infrastructure to access any forms of identity and access management tools (IAMs) which in turn can implement or interface to one or more security agents (e.g., security agents 756₁, security agents 756₂, . . . , security agents 756_{N}). Such security agents are configured to produce access tokens, which in turn provide authentication of users and/or authentication of corresponding user devices, as well as to provide access controls (e.g., allow or deny) corresponding to various types of requests by devices of the secure edge infrastructure.

As shown, the cloud infrastructure is also interfaced for access to service modules 716. The various service modules can be accessed over the shown service on demand backbone 748 using any known technique and for any purpose (e.g., for downloading and/or for application programming interfacing and/or for local or remote execution). The service modules can be partitioned in any manner. The partitioning shown (e.g., into modules labeled as classifier agents 724, folder structure generators 726, workflow management agents 728, access monitoring agents 730, auto-tagging agents 744, and policy enforcement agents 746) is presented merely for illustrative purposes and many other service modules can be made accessible to the cloud infrastructure. Some of the possible service modules are discussed hereunder.

Classifier agents serve to automatically classify (and find) files by defining and associating metadata fields with content objects, and then indexing the results of that classification. In some cases a classifier agent processes one or more content objects for easy retrieval (e.g., via bookmarking).

Folder structure generators relieve users from having to concoct names and hierarchies for folder structures. Rather, names and hierarchies of folder structures are automatically generated based on the actual information in the content objects and/or based on sharing parameters and/or based on events.

Workflow management agents provide automation to deal with repeatable tasks and are configured to create workflow triggers that in turn invoke workflows at particularly-configured entry points. Triggers can be based on any content and/or based on any observable events. Strictly as examples, triggers can be based on events such as, content reviews, employee onboarding, contract approvals, and so on.

Access monitoring agents observe and keep track of use events such as file previews, user uploads and downloads, etc. In some embodiments, access monitoring agents are interfaced with presentation tools so as to present easy-to-understand visuals (e.g., computer-generated graphical depictions of observed user events).

Auto-tagging agents analyze combinations of content objects and events pertaining to those content objects such that the analyzed content objects can be automatically tagged with highly informative metadata and/or automatically stored in appropriate locations. In some embodiments, one or more auto-tagging agents operate in conjunction with folder structure generators so as to automatically analyze, tag and organize content (e.g., unstructured content). Generated metadata is loaded into a content object index to facilitate near instant retrieval of sought after content objects and/or their containing folders.

Policy enforcement agents run continuously (e.g., in the background) so as to aid in enforcing security and compliance policies. Certain policy enforcement agents are configured to deal with items such as content object retention schedules, achievement of time-oriented governance requirements, and establishment and maintenance of trust controls (e.g., smart access control exceptions). Further, certain policy enforcement agents apply machine learning techniques to deal with items such as dynamic threat detection.

The CCM, either by operation of individual constituents and/or as a whole, facilitates collaboration with third parties (e.g., agencies, vendors, external collaborators, etc.) while maintaining sensitive materials in one secure place. The CCM implements cradle-to-grave controls that result in automatic generation and high availability of high-quality content through any number of collaboration cycles (e.g., from draft to final to disposal, etc.) while constantly enforcing access and governance controls.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for processing a computer-implemented content management system workflow, the method comprising:
configuring a content management system to implement a workflow process wherein the content management system (CMS) exposes instances of stored content objects to a plurality of user devices through an electronic interface;
identifying metadata maintained by the CMS for the stored content objects;
identifying a generative AI entity (GAIE) to interact with the CMS;
forming a GAIE prompt, wherein the GAIE prompt comprises at least a portion of the metadata identified from the CMS for the stored content objects;
receiving a response from the GAIE, wherein the response corresponds to the GAIE prompt; and
using, by the CMS, the response from the GAIE to implement processing of the content management system workflow.

2. The method of claim 1, wherein the response from the GAIE is used (1) to advance the content management system workflow, or (2) to provide a metadata value to the content management system workflow, or (3) is used in a further GAIE prompt to request further information from the GAIE.

3. The method of claim 2, wherein the further information from the GAIE is used to inform a decision of the content management system workflow.

4. The method of claim 2, wherein one or more values corresponding to the metadata are derived at least in part from the response from the AI entity.

5. The method of claim 4, wherein the one or more values corresponding to the metadata comprises a summary of all or portions of the content object.

6. The method of claim 5, wherein at least a portion of the summary comprises one or more of, a total contract value, a summary of quarterly results, an indication of a policy violation, a summary of contents of a CMS folder, or a summary of user notifications.

7. The method of claim 5, wherein at least a portion of the summary is provided as a further GAIE prompt to the AI entity.

8. The method of claim 7, further comprising receiving a second response from the AI entity.

9. The method of claim 8, wherein the second response is a blog post.

10. A non-transitory computer readable medium having stored thereon a sequence of instructions which, when stored in memory and executed by one or more processors causes the one or more processors to perform a set of acts for processing a computer-implemented content management system workflow, the set of acts comprising:
configuring a content management system to implement a workflow process wherein the content management system (CMS) exposes instances of stored content objects to a plurality of user devices through an electronic interface;
identifying metadata maintained by the CMS for the stored content objects;
identifying a generative AI entity (GAIE) to interact with the CMS;
forming a GAIE prompt, wherein the GAIE prompt comprises at least a portion of the metadata identified from the CMS for the stored content objects;
receiving a response from the GAIE, wherein the response corresponds to the GAIE prompt; and
using, by the CMS, the response from the GAIE to implement processing of the content management system workflow.

11. The non-transitory computer readable medium of claim 10, wherein the response from the GAIE is used (1) to advance the content management system workflow, or (2) to provide a metadata value to the content management system workflow, or (3) is used in a further GAIE prompt to request further information from the GAIE.

12. The non-transitory computer readable medium of claim 11, wherein the further information from the GAIE is used to inform a decision of the content management system workflow.

13. The non-transitory computer readable medium of claim 11, wherein one or more values corresponding to the metadata are derived at least in part from the response from the AI entity.

14. The non-transitory computer readable medium of claim 13, wherein the one or more values corresponding to the metadata comprises a summary of all or portions of the content object.

15. The non-transitory computer readable medium of claim 14, wherein at least a portion of the summary comprises one or more of, a total contract value, a summary of quarterly results, an indication of a policy violation, a summary of contents of a CMS folder, or a summary of user notifications.

16. The non-transitory computer readable medium of claim 14, wherein at least a portion of the summary is provided as a further GAIE prompt to the AI entity.

17. The non-transitory computer readable medium of claim 16, further comprising instructions which, when stored in memory and executed by the one or more processors causes the one or more processors to perform acts of receiving a second response from the AI entity.

18. The non-transitory computer readable medium of claim 17, wherein the second response is a blog post.

19. A system for processing a computer-implemented content management system workflow, the system comprising:
a storage medium having stored thereon a sequence of instructions; and
one or more processors that execute the sequence of instructions to cause the one or more processors to perform a set of acts, the set of acts comprising,
configuring a content management system to implement a workflow process wherein the content management system (CMS) exposes instances of stored content objects to a plurality of user devices through an electronic interface;
identifying metadata maintained by the CMS for the stored content objects;
identifying a generative AI entity (GAIE) to interact with the CMS;
forming a GAIE prompt, wherein the GAIE prompt comprises at least a portion of the metadata identified from the CMS for the stored content objects;
receiving a response from the GAIE, wherein the response corresponds to the GAIE prompt; and
using, by the CMS, the response from the GAIE to implement processing of the content management system workflow.

20. The system of claim 19, wherein the response from the GAIE is used (1) to advance the content management system workflow, or (2) to provide a metadata value to the content management system workflow, or (3) is used in a further GAIE prompt to request further information from the GAIE.
